(19) United States
(12) Patent Application Publication
(10) Pub. No.: US 2026/0236761 A1
(43) Pub. Date: Aug. 13, 2026

(54) GENERATING RESPONSES TO QUERIES USING GENERATIVE NEURAL NETWORKS

(71) Applicant: GDM Holding LLC, Mountian View, CA (US)

(72) Inventors: Danny Karmon, Petah Tikva (IL); Gil Fidel, Petah Tikva (IL)

(21) Appl. No.: 19/051,001

(22) Filed: Feb. 11, 2025

(51) Int. Cl. G06N 3/08; G06N 3/0475

(52) U.S. Cl. CPC G06N 3/08; G06N 3/0475

(57) ABSTRACT

Methods, systems, and apparatus, including computer programs encoded on a computer storage medium, for generating responses to queries. In one aspect, a method comprises: receiving a query; generating an input prompt for a generative neural network from the query; processing the input prompt using the generative neural network to generate a snippet of code; and executing the snippet of code to generate a response to the query.

### BACKGROUND

This specification relates to processing inputs using neural networks to generate responses.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that generates responses to queries using generative neural networks. In particular, the system can use a generative neural network to generate a snippet of code that, when executed, generates a response to a query.

In general, one innovative aspect of the subject matter described in this specification can be embodied in methods that include the actions of receiving a query; generating an input prompt for a generative neural network from the query; processing the input prompt using the generative neural network to generate a snippet of code, wherein the snippet of code comprises a sequence of calls, the sequence of calls comprising a first call to an external tool and a second call to a second generative neural network; and executing the snippet of code to generate a response to the query.

In some implementations, the second generative neural network is the generative neural network.

In some implementations, the snippet of code assigns a variable name to an output of the first call to the external tool.

In some implementations, the second call comprises one or more inputs, and wherein the one or more inputs comprise the variable name.

In some implementations, executing the snippet of code comprises: calling the external tool according to the first call; assigning the variable name to the output of the first call; and calling the second generative neural network according to the second call by processing a second input prompt comprising the output identified by the variable name using the second generative neural network.

In some implementations, calling the second generative neural network according to the second call comprises generating the second input prompt by including the output identified by the variable name in the second input prompt.

In some implementations, generating the second input prompt comprises including an instruction to generate an answer to a question about the output.

In some implementations, the one or more inputs comprise an identifier of data to be extracted from the output, and wherein generating the second input prompt comprises including an instruction to extract data identified by the identifier from the output.

In some implementations, the snippet of code comprises code that, when executed, generates the response to the query based on an output of the second generative neural network.

In general, another innovative aspect of the subject matter described in this specification can be embodied in methods that include the actions of obtaining a plurality of queries and a respective code trajectory for each query, wherein each code trajectory comprises a sequence of steps for generating a response to the query, wherein each step comprises any one or more of: a snippet of code, or an output generated from causing a snippet of code from one or more preceding steps to be executed; generating, for each code trajectory, a modified code trajectory, wherein the modified code trajectory comprises a single snippet of code that, when executed, generates the response to the query; generating, for each code trajectory, a training example, wherein the training example comprises the modified code trajectory for the code trajectory and the query for the code trajectory; and training a generative neural network on the training examples.

In some implementations, generating, for each code trajectory, the modified code trajectory comprises: processing at least the code trajectory using a third generative neural network to generate the modified code trajectory.

In some implementations, the single snippet of code comprises a call to a fourth generative neural network.

In some implementations, processing at least the code trajectory using the third generative neural network comprises processing the code trajectory and an instruction to generate a single snippet of code for the code trajectory using the third generative neural network.

In some implementations, the instruction further comprises one or more code translation examples, each comprising an example code trajectory and an example modified code trajectory.

In some implementations, the third generative neural network is the generative neural network.

In some implementations, the generative neural network has been pre-trained on a language modeling task to determine trained values of parameters of the generative neural network, and wherein processing at least the code trajectory using the third generative neural network comprises processing at least the code trajectory in accordance with the trained values of the parameters of the generative neural network.

In some implementations, generating, for each code trajectory, the modified code trajectory comprises: processing at least the code trajectory using a third generative neural network to generate a plurality of candidate modified code trajectories; and selecting the modified code trajectory from the candidate modified code trajectories based on any one or more of a code quality measure for each candidate modified code trajectory, a tool call similarity measure for each candidate modified code trajectory, or a tool parallelization measure for each candidate modified code trajectory.

In some implementations, one or more of the snippets of code comprise a respective call to an external tool.

In some implementations, the single snippet of code comprises the respective calls of the one or more snippets of code.

Other implementations of these aspects include corresponding systems, apparatus, and computer programs, configured to perform the actions of the methods, encoded on computer storage devices.

The subject matter described in this specification can be implemented in particular embodiments so as to realize one or more of the following advantages.

The system described in this specification can generate accurate responses to queries for a variety of tasks. For example, the system can generate responses to queries for tasks such as natural language processing, planning, or multi-hop reasoning tasks by executing a snippet of code generated by a generative neural network. By executing a snippet of code generated by the generative neural network in order to carry out the task, the system can leverage the reasoning and task decomposition capabilities in code generation learned during training of the generative neural network in order to more effectively respond to user queries.

Conventional systems for generating responses to queries by generating and executing code involve iteratively generating code for multiple steps when responding to the query. For example, a given step can include code that, when executed, calls an external tool and prints the output of the tool. To generate the code for the next step, these conventional systems provide a prompt that includes the output printed in the preceding step, the query, an instruction, a description of available tools, and the snippet of code and the outputs of one or more previous steps to a generative neural network to generate the code for the next step. The system can continue generating code in further steps until the generative neural network determines it can generate a response to the query. Thus to generate a response to a query, conventional systems can require multiple iterations of generation using the generative neural network, and conditioned on prompts that can have a large number of tokens, requiring a large amount of computing time and resources for processing prompts and generating outputs. For example, the generative neural network consumes more computational resources, e.g., memory and computing time, to process a larger context. In conventional systems, the context provided to the generative neural network can grow larger at each step, increasing prefill token cost. For example, tokenizing a larger context, and generating embeddings for a larger number of tokens, consumes more computing resources than tokenizing a smaller context and generating embeddings for a smaller number of tokens. In addition, for a generative neural network that applies a self-attention mechanism, processing a larger number of tokens increases the number of computations in the self-attention mechanism. As another example, the generative neural network consumes computational resources to generate each token of the output. For example, in an autoregressive generative neural network, generating each token requires processing the context and any previously generated tokens. In conventional systems, the generative neural network may generate a large number of snippets of code for a large number of steps, increasing decode token cost over the steps compared to generating a smaller number of tokens.

The system described in this specification can generate a response to a query by generating and executing a single snippet of code that, when executed, generates a response to the query. For example, the system can generate the single snippet of code in one iteration by processing an input prompt using a generative neural network that has been trained to generate a single snippet of code for responding to a given query. The single snippet of code can include fewer tokens than are included in multiple snippets of code for multiple steps, which requires less decoding during inference. Thus the system described in this specification can reduce the computational cost of generating the response to the query, and reduce the latency to generate the snippet of code and the response to the query.

Furthermore, by generating a single snippet of code in one iteration by processing an input prompt to the generative neural network, the system described in this specification does not increase the size of the context at multiple iterations. For example, rather than providing outputs of external tools called in previous steps as part of the context to generate the next step, the system described in this specification can generate a single snippet of code that includes a call to the generative neural network or another generative neural network to process the output of a previously called external tool in the single snippet of code. The call to the generative neural network can include a shorter context than the context required to generate snippets of code iteratively. In some examples, the system described in this specification makes fewer calls overall to generate the response compared to conventional systems. Thus the system described in this specification can reduce the amount of computing time and resources used by requiring fewer calls to a generative neural network, and processing shorter prompts using the generative neural network.

The system described in this specification can train the generative neural network to generate a single snippet of code given a query. For example, the generative neural network can have been pre-trained on a language modeling task. The system can further train, e.g., through supervised fine-tuning, the generative neural network on training examples in order to improve the performance of the generative neural network in generating single snippets of code that are responsive to queries. In some examples, the system can generate the training examples. Thus the system increases the number of training examples available for training, resulting in improved training and performance of the generative neural network compared to a generative neural network trained on a limited amount of training data.

In some examples, the system can generate the training examples using a prior checkpoint of the generative neural network or another instance of the generative neural network. By making use of a single generative neural network, the system can reduce the amount of computing resources required to pre-train and maintain the generative neural network compared to using multiple generative neural networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for generating responses.

FIG. 2 shows an example snippet of code.

FIG. 3 is a flow diagram of an example process for generating a response to a query.

FIG. 4 is a flow diagram of an example process for executing a snippet of code.

FIG. 5 shows an example training data generation system.

FIG. 6 is a flow diagram of an example process for training a generative neural network.

FIG. 7 shows an example code trajectory and an example modified code trajectory.

Like reference numbers and designations in the various drawings indicate like elements.

### DETAILED DESCRIPTION

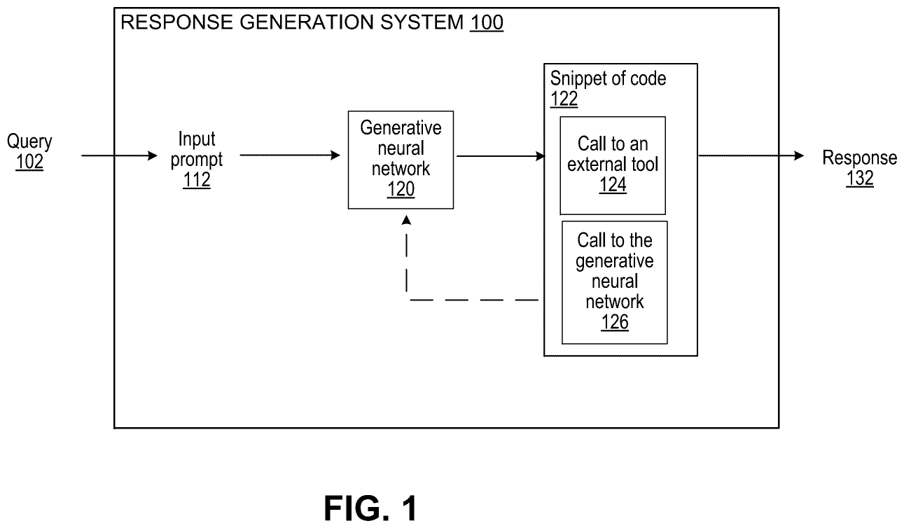

FIG. 1 shows an example system 100 for generating responses. The system 100 is an example of a system implemented as computer programs on one or more computers in one or more locations in which the systems, components, and techniques described below are implemented.

The system 100 generates a response 132 for a given query 102. The response 132 can include, for example, text, audio data, image data, or video data that is responsive to the query 102.

To generate the response 132, the system 100 receives the query 102. The query 102 can specify a task to be performed. For example, the query 102 can include text that includes a question or an instruction to perform any of a variety of tasks. In some examples, the query 102 can include input data such as audio data, image data, or video data, and text that includes a question or an instruction about the input data.

As particular examples, the tasks can include tasks that can be completed by performing a sequence of actions. In some examples, the sequence of actions can include actions performed by calling an external tool or by calling a generative neural network. The sequence of actions can be represented, e.g., as a snippet of code. The snippet of code, when executed, can perform the sequence of actions. Some example tasks are described below.

As a particular example, the query 102 can include the text “best hikes near Los Angeles: compare them by distance, difficulty, and elevation.” Performing the task can require, for example, querying a search engine, querying for geographic information, extracting information from the query results, and summarizing the extracted information or sorting the extracted information.

In some examples, the system 100 receives the query 102 from a user. For example, the system 100 can receive the query 102 from a user through a user interface of a user device.

The system 100 generates an input prompt 112 from the query 102. For example, the system 100 can generate the input prompt 112 to include the query 102 and an instruction for a generative neural network 120 to generate a snippet of code for responding to the query 102.

In some examples, the system 100 can generate the input prompt 112 to include a description of each of one or more calls that can be included in the snippet of code. The description for a call can include a text sequence that specifies any one or more of: what the call can be used for, in what situations to include the call, the syntax of the call, a description of input parameters the call can include, e.g., data type or format, or a description of any outputs of executing the call, e.g., data type or format. As a particular example, the description can be an application programming interface (API) description for a call to an external tool, a call to the generative neural network 120, or a call to another generative neural network. An external tool includes software that is external to the generative neural network 120, e.g., executes externally to the generative neural network 120. The external tool can be queried by the system 100 to obtain responses to queries. For example, a call to an external tool can return an output from the external tool.

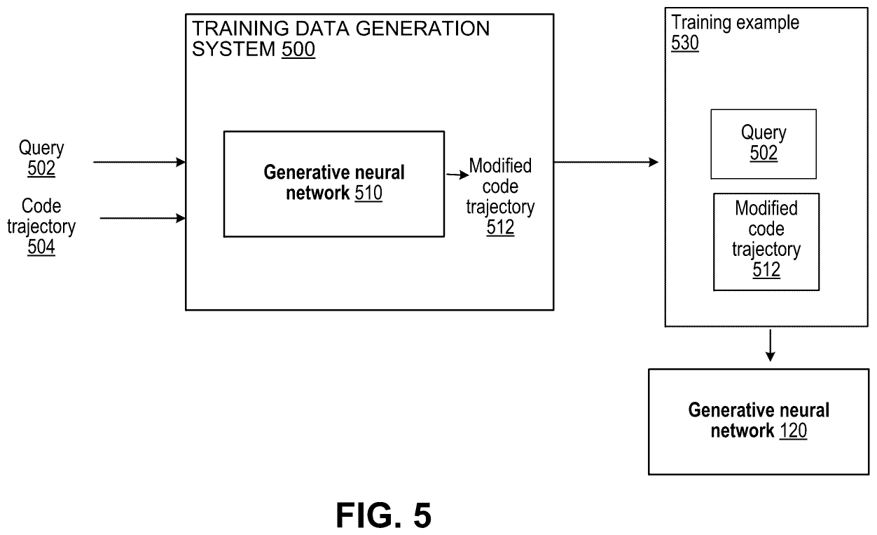

The system 100 can process the input prompt 112 using the generative neural network 120 to generate the snippet of code 122. The generative neural network 120 is described in further detail below. In some examples, the generative neural network 120 can be trained as described with reference to FIGS. 5-7.

The snippet of code includes computer code in a programming language that is described by the input prompt 112 or that follows the input prompt 112. For example, the snippet of code, when executed, can generate a response for the query 102 of the input prompt 112. Examples of programming languages include Python, JavaScript, or C++.

The snippet of code 122 includes a sequence of calls, e.g., function calls. In some examples, a call can be a call to an external tool, e.g., a function call that, when executed, invokes an external tool that is external to the generative neural network 120, and returns an output from the external tool. The external tool can be, for example, a search engine tool, a geographic information tool, or an image processing or video processing tool.

In some examples, a call can be a call to the generative neural network 120, e.g., a function call that, when executed, processes an input prompt using the generative neural network 120 and returns an output from the generative neural network 120.

Although this specification describes examples of calls to the generative neural network 120, in some examples, a call can be a call to another generative neural network, e.g., a function call that, when executed, processes an input prompt using the other generative neural network and returns an output from the generative neural network. In some examples, the other generative neural network can have a similar architecture as the generative neural network 120. In some examples, the other generative neural network can have been trained, e.g., fine-tuned, to perform the type of task of the call.

In some examples, the other generative neural network can be one of multiple generative neural networks. For example, each of the multiple generative neural networks can have been trained to perform a different type of task. For example, a generative neural network can have been trained to perform data extraction, another generative neural network can have been trained to generate content, and another generative neural network can have been trained to generate responses to prompts. In these examples, the call can be a call to a particular generative neural network. In some examples, one or more of the multiple generative neural networks can be smaller generative neural networks, e.g., having a smaller number of parameters than the generative neural network 120. Smaller neural networks require fewer computing resources during training and inference. The system can thus reduce the computing resources required to train and perform inference using multiple generative neural networks that are specialized for a particular type of task compared to using the generative neural network 120 for multiple types of tasks.

In some examples, a call can include one or more inputs that specify input values for input parameters of the call. For example, an input can include text such as a string that is the input value. As another example, an input can include a variable name that represents the data values, e.g., a data structure that includes the input values.

As an example, for a call to an external tool, one or more of the inputs can specify at least part of the query to the external tool.

As another example, for a call to the generative neural network 120, one or more of the inputs can specify at least part of a second input prompt to be processed by the generative neural network 120.

As particular examples, the call can be a call to perform a task specified by a given input prompt, a call to generate content based on a given input prompt, or a call to generate a response to a given input prompt. For example, the call can include an input that specifies the input prompt to be processed by the generative neural network.

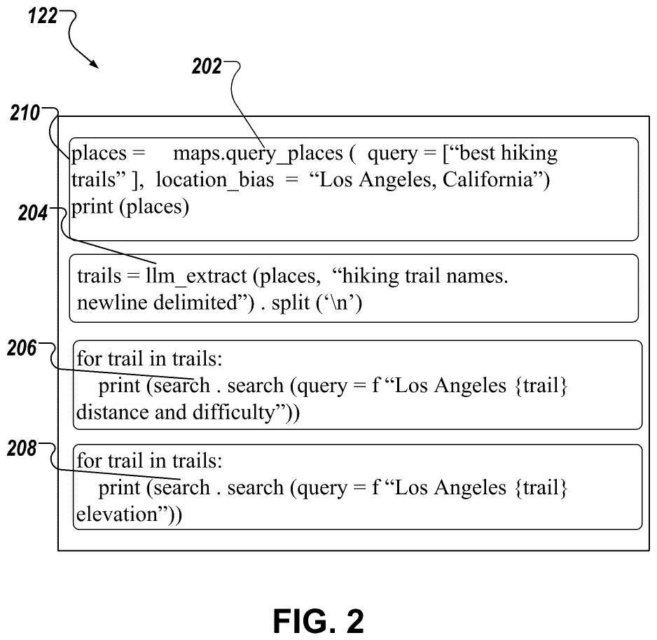

In the example of FIG. 1, the snippet of code 122 can include at least a call 124 to an external tool and a call 126 to the generative neural network 120. As a particular example, for performing a task that requires querying a search engine, querying for geographic information, extracting information from the query results, and summarizing the extracted information or sorting the extracted information, the snippet of code can include a call to a search engine tool, a call to a geographic information tool, a call to the generative neural network 120 to extract information or summarize information, or code that summarizes or sorts information. An example snippet of code 122 with multiple function calls is described below with reference to FIG. 2.

The system 100 thus generates a single snippet of code 122 for generating the response 132. For example, rather than iteratively generating multiple snippets of code that, when executed, can generate the response 132, using multiple calls to a generative neural network, the system 100 generates the single snippet of code 122 using a single call to the generative neural network 120.

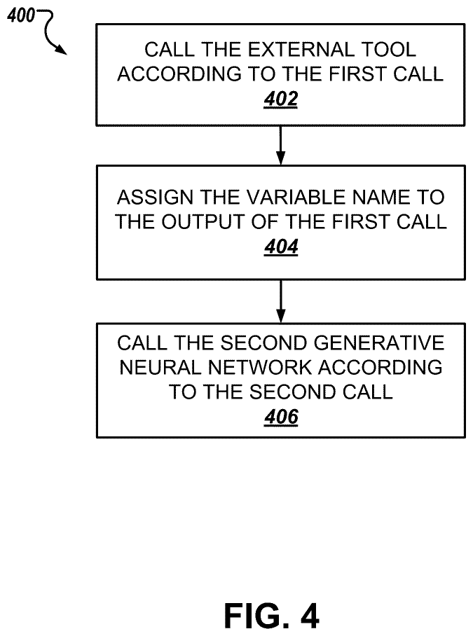

The system 100 can execute the snippet of code 122 to generate the response 132. For example, the system 100 can cause the snippet of code 122 to be executed in an execution environment appropriate for the programming language of the snippet of code 122. Executing the snippet of code 122 can include executing the call 124 to the external tool and the call 126 to the generative neural network 120. Executing the snippet of code 122 can also include executing code that generates the response 132 based on outputs of one or more calls to external tools or calls to the generative neural network 120. Executing the snippet of code 122 is described below in further detail with reference to FIG. 4.

Example tasks include a language processing task. For example, the task can be a natural language processing or understanding task, e.g., an entailment task, a paraphrase task, a textual similarity task, a sentiment task, a sentence completion task, a grammaticality task, and so on, that operates on a sequence of text in some natural language.

For example, the input data can include text and the task can include generating a sequence of text responsive to the input data. For example, the input data can include reasoning problems such as math problems or multi-hop reasoning problems. Performing the task can require calling external tools such as a search engine tool, a math engine tool, or a calculator tool, or calling the generative neural network to perform tasks such as question answering or data extraction on the outputs of the external tools.

As another example, the task can be an agent control or planning task, where the input data includes an observation characterizing the state of an environment and the output defines an action to be performed by the agent in response to the observation. The agent can be, e.g., a real-world or simulated robot, a control system for an industrial facility, or a control system that controls a different kind of agent. For example, performing the task can require calling external tools such as a computer vision library or image processing tool, or calling the generative neural network to perform summarization or data extraction on the outputs of the external tools.

As another example, the task can be a text to speech task, where the input is text in a natural language or features of text in a natural language and the output is a spectrogram or other data defining audio of the text being spoken in the natural language. For example, performing the task can require calling external tools such as a text to speech library, or calling the generative neural network to perform speech to text given the generated speech, to determine the fidelity of the generated speech to the input text.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. For example, performing the task can require calling external tools such as a health prediction tool, or calling the generative neural network to perform summarization to summarize the prediction.

As another example, the task can be a summarization task in which the outputs can include text summaries of, e.g., text, images, video, audio, etc. specified by the input data. For example, performing the task can require calling external tools such as an image processing tool to generate a caption for each image, or calling the generative neural network to perform summarization of the captions.

As another example, the task can be an image, audio, or video processing task. For example, the input data can include a description of an image, audio, or video to be generated and processed. Performing the task can include calling external tools such as an image, audio, or video generation tool, or calling the generative neural network to process the generated image, audio, or video. For example, the call to the generative neural network can be a call to convert the generated image, audio, or video, to text, e.g., by performing optical character recognition or by performing speech-to-text.

As another example, the task can be an image generation task, i.e., receive input data and to process the input data to generate an image for the input data. For example, the input data can include text and/or an image. For example, performing the task can require calling external tools such as an image generation tool, or calling the generative neural network to perform image modification to edit the image.

As another example, the task can be a video generation task, i.e., receive input data and to process the input data to generate a video for the input data. For example, the input data can include text, an image, and/or a video. For example, performing the task can require calling external tools such as a video generation tool, or calling the generative neural network to perform video modification to edit the video.

As another example, the task can be an audio generation task, i.e., receive input data and to process the input data to generate audio for the input data. For example, the input data can include text, audio, an image, and/or a video. For example, performing the task can require calling external tools such as an audio generation tool, or calling the generative neural network to perform audio modification to edit the audio.

In some examples, the system 100 can provide the response 132 for presentation to a user. For example, the system 100 can provide data representing the response 132 to a user device of the user.

The generative neural network 120 is configured to perform a code generation task. For example, the generative neural network 120 can receive a context input, also referred to as an input prompt, that includes a text description of a desired piece of code or a snippet of computer code in a programming language. The generative neural network 120 can generate an output sequence that is a response to the context input. The output sequence can be computer code, e.g., a snippet of code that is described by the context input or a snippet of code that follows the context input in a computer program.

The generative neural network 120 can generate other types of outputs in addition to code. As an example, the language model neural network can generate text sequences, i.e., each output sequence generated by the language model neural networks is a sequence of text tokens from a vocabulary of text tokens that includes, e.g., one or more of characters, sub-words, words, punctuation marks, numbers, or other symbols that appear in natural language text.

As another example, the context input can be an input sequence of text and the output sequence is another sequence of text, e.g., a completion of the input sequence of text, a paraphrase of the input sequence of text, a response to a question posed in the input sequence, or a sequence of text that is about a topic specified by the input sequence of text.

The generative neural network 120 can have any appropriate architecture for performing a code generation task. For example, the generative neural network 120 can include a language model neural network. The language model neural network can have any of a variety of Transformer-based neural network architectures, e.g., encoder-only Transformer architectures, encoder-decoder Transformer architectures, decoder-only Transformer architectures, other attention-based architectures, and so on.

In general a Transformer-based architecture can be one which is characterized by having a succession of self-attention neural network layers. A self-attention neural network layer has an attention layer input for each element of the input and is configured to apply an attention mechanism over attention layer inputs to generate an attention layer output for each element of the input. There are many different attention mechanisms that may be used.

Examples of such architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020; Aakanksha Chowdhery, et al. PaLM: Scaling Language Modeling with Pathways, arXiv preprint arXiv:2204.02311; Rohan Anil, et al. Palm 2 technical report. arXiv preprint arXiv:2305.10403, 2023, and Gemini Team, et al., Gemini: a family of highly capable multimodal models. arXiv preprint arXiv:2312.11805, 2023.

The language model neural network can be configured to generate output sequences made up of tokens from a vocabulary. In some examples, the vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code. Additionally, or alternatively, the vocabulary of tokens can include tokens that can represent data other than text, such as images, videos, or audio. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

As a particular example, the generative neural network 120 can be an auto-regressive Transformer-based neural network that includes a plurality of layers that each apply a self-attention operation.

In particular, the generative neural network 120 can be an auto-regressive neural network that auto-regressively generates the output sequence of tokens by generating each particular token in the output sequence conditioned on a current input sequence that includes (i) the input sequence followed by (ii) any tokens that precede the particular token in the output sequence.

More specifically, to generate a particular token, the generative neural network 120 can process the current input sequence to generate a score distribution, e.g., a probability distribution, that assigns a respective score, e.g., a respective probability, to each token in the vocabulary of tokens. The generative neural network 120 can then select, as the particular token, a token from the vocabulary using the score distribution. For example, the generative neural network 120 can greedily select the highest-scoring token or can sample, e.g., using top-k sampling, nucleus sampling or another sampling technique, a token from the distribution.

Prior to using the language model neural network to generate model outputs, the language model neural network is trained e.g., by the system 100 or by one or more other systems. In some examples, the generative neural network 120 can have been trained, e.g., further trained, on a fine-tuning dataset that includes multiple fine-tuning examples. Each fine-tuning example can include a fine-tuning input that includes a training query and a ground-truth snippet of code. Training the generative neural network 120 is described below with reference to FIGS. 5-7.

In some examples, the system 100 or the other system(s) trains the language model neural network on a language modeling task, e.g., a task that requires predicting, given a current sequence of text tokens, the next token that follows the current sequence in the training data. Equivalently, the language modeling task can require, for each given unlabeled text sequence in a training data set, predicting a text sequence that followed the given unlabeled text sequence in a corresponding document. As a particular example, the language model neural network can be pre-trained on a maximum-likelihood objective on a large dataset of text, e.g., text that is publicly available from the Internet or another text corpus.

FIG. 2 shows an example snippet of code 122. The snippet of code 122 is an example snippet of code that can be generated using a generative neural network as described above with reference to FIG. 1.

The snippet of code 122 can include one or more calls to external tools and one or more calls to a generative neural network, e.g., the generative neural network that generated the snippet of code 122. In particular, for one or more of the calls to external tools, the snippet of code 122 can assign a respective variable name to the output of the external tool. Thus the output of the external tool can be represented within the snippet of code 122 using the variable name.

In some examples, a call to an external tool or to the generative neural network can include one or more inputs. As a particular example, the snippet of code 122 can include a variable name as an input to the call. Thus, when the snippet of code 122 is executed, in order to execute the call, the variable name is replaced with the output that the variable name represents.

For example, the snippet of code 122 includes a sequence of calls that includes calls 202, 204, 206, and 208. In the example of FIG. 2, the calls 202, 206, and 208 are calls to external tools. The call 204 is a call to the generative neural network.

For example, the call 202, <<maps.query_places(query=[“best hiking trails”], location_bias=“Los Angeles, California”)>>, is a call to a geographic information tool <<maps.query_places>>. The call 202 includes two inputs, <<query=[“best hiking trails”]>> and <<location_bias=“Los Angeles, California>”>>. The input value <<[“best hiking trails”]>> corresponds to the input parameter <<query>>, and “Los Angeles, California” corresponds to the input parameter <<location_bias>>. Upon execution, the system provides at least the two input values to the external tool. The external tool returns an output identifying multiple places that are appropriate for the <<query>> input parameter and the <<location_bias>> input parameter of the call. For example, the output can include a data structure, e.g., a data type that includes a collection of objects that each include attributes such as title, location, and description.

In the example of FIG. 2, the snippet of code 122 assigns a variable name 210 to an output of an external tool. For example, the snippet of code 122 assigns the variable name 210, <<places>>, to the output of the call 202. The snippet of code 122 can include the variable name 210 in further lines of code, such as other calls. For example, as described below, the call 204 includes the variable name 210 as an input.

The call 204 includes <<llm_extract(places, “hiking trail names.newline delimited”)>>. The call 204 includes two inputs, <<places>> and <<“hiking trail names.newline delimited”>>. The input <<places>> is a variable name that represents the data structure described above. The input <<“hiking trail names.newline delimited”>> includes an identifier of data to be extracted from the input <<places>>. To execute the call 204, the system can replace the variable name <<places>> with the output that <<places>> represents. For example, the system can generate a second input prompt that includes the data represented by the input <<places>> and an instruction to extract data identified by the input <<“hiking trail names.newline delimited”>> from <<places>>.

The call 206, <<search.search(query=f “Los Angeles {trail} distance and difficulty”)>>, is a call to a search engine tool, <<search.search>>. The call 206 includes an input, <<query=f“Los Angeles {trail} distance and difficulty”>>. The input value <<f “Los Angeles {trail} distance and difficulty”>>, where {trail} is a variable that represents a list, corresponds to the input parameter <<query>>. Upon execution, the system provides at least the input value to the external tool. The external tool returns an output identifying search engine results for the distance and difficulty of each of multiple trails in <<trail>>.

The call 208, <<search.search(query=f “Los Angeles {trail} elevation”)>>, is a call to the search engine tool, <<search.search>>. The call 208 includes an input, <<query=f “Los Angeles {trail} elevation”>>. The input value <<f “Los Angeles {trail} elevation”>>, where {trail} is a variable that represents a list, corresponds to the input parameter <<query>>. Upon execution, the system provides at least the input value to the external tool. The external tool returns an output identifying search engine results for the elevation of each of multiple trails in <<trail>>.

The snippet of code 122 can also include other programming logic such as if-else statements, loops, variable assignment, algorithms, etc.

The snippet of code 122 can also include code that, when executed, generates the response to the query. For example, the snippet of code 122 can include code that processes the outputs of the call 206 and the call 208 to generate a response that compares hikes of Los Angeles by distance, difficulty, and elevation.

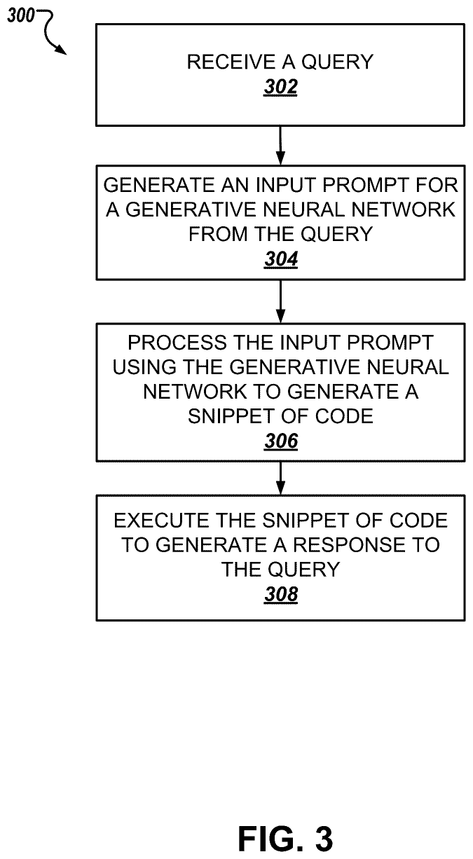

FIG. 3 is a flow diagram of an example process 300 for generating a response to a query. For convenience, the process 300 will be described as being performed by a system of one or more computers located in one or more locations. For example, a system for generating responses, e.g., the system 100 of FIG. 1, appropriately programmed, can perform the process 300.

The system receives a query (step 302). The query can include text that includes a question or an instruction. In some examples, the query can include data such as audio data, image data, or video data, and text that includes a question or an instruction about the data.

In some implementations, the system can receive the query from a user.

The system generates an input prompt for a generative neural network from the query (step 304). For example, the system can include the query and an instruction to generate a snippet of code for responding to the query.

In some examples, the system can generate the input prompt to include a description of each of one or more calls that can be included in the snippet of code. For example, the system can maintain a description of each of a set of external tool calls or calls to the generative neural network or other generative neural networks that the system can access or execute.

The system processes the input prompt using the generative neural network to generate a snippet of code (step 306). For example, the system generates the snippet of code using a single call to the generative neural network, e.g., using a single decoding process given the input prompt. For example, rather than processing multiple different inputs using a generative neural network to generate multiple snippets of code, the system processes the input prompt using the generative neural network to generate a single snippet of code. In some examples where the generative neural network generates the snippet of code autoregressively, the generative neural autoregressively generates the output sequence of tokens of the snippet of code by generating each particular token in the output sequence conditioned on a current input sequence that includes (i) the input sequence followed by (ii) any tokens that precede the particular token in the output sequence. In some other examples where the generative neural network generates the snippet of code non-autoregressively, the generative neural network generates the snippet of code in a single pass given the input prompt.

The snippet of code can include a sequence of calls. The sequence of calls can include, for example, function calls to external tools, or function calls to a second generative neural network. The second generative neural network can be the generative neural network or another generative neural network.

As a particular example, the sequence of calls can include a first call to an external tool and a second call to the generative neural network. In some examples, the sequence of calls can include multiple calls to an external tool and multiple calls to the generative neural network.

In some examples, the snippet of code can include code that, when executed, generates the response to the query based on an output of the second generative neural network. For example, when executed, the code can process the outputs of one or more calls to generate the response to the query, e.g., by performing calculations, analyzing data, generating visualizations, by performing natural language processing, etc.

The system executes the snippet of code to generate a response to the query (step 308). For example, the system can cause the snippet of code to be executed. Executing a snippet of code that includes a first call to an external tool and a second call to the second generative neural network is described below with reference to FIG. 4.

FIG. 4 is a flow diagram of an example process 400 for executing a snippet of code. For convenience, the process 400 will be described as being performed by a system of one or more computers located in one or more locations. For example, a system for generating responses, e.g., the system 100 of FIG. 1, appropriately programmed, can perform the process 400.

In the example of FIG. 4, the snippet of code includes at least a first call to an external tool and a second call to the second generative neural network. In some examples, the first call includes one or more inputs, e.g., input values or variable names representing input values. The snippet of code includes at least one variable name. For example, the snippet of code can include code that assigns a variable name to an output of the first call. The second call includes one or more inputs that include the variable name.

During execution of the snippet of code, the system performs steps 402 and 404 without calling the second generative neural network. The system calls the second generative neural network in step 406.

During execution of the snippet of code, the system calls the external tool according to the first call to the external tool included in the snippet of code (step 402). For example, the system can provide a request to the external tool according to the first call. In examples where the first call includes one or more inputs, the system can include the input values specified by the inputs in the snippet of code in the request to the external tool. In response to providing the request to the external tool, the system receives the output from the external tool.

The system assigns the variable name to the output of the first call (step 404). The variable name and the assignment of the variable name are included in the snippet of code. The system can thus use the variable name to further process the output of the first call. For example, as described with reference to FIG. 2, the snippet of code can assign the variable name 210 to the output of the call 202.

The system calls the second generative neural network according to the second call to the second generative neural network (step 406). The second call is included in the snippet of code. The second call includes an input that includes the variable name. For example, the system can call the second generative neural network by processing a second input prompt that includes the output identified by the variable name using the second generative neural network.

For example, the system can generate the second input prompt. For example, the system can include the output identified by the variable name in the second input prompt.

In some examples, the system can include an instruction to generate a response about the output in the second input prompt. For example, the system can include an instruction to generate an answer to a question about the output in the second input prompt.

In some examples, the instruction can be a predetermined instruction for the second call. For example, for the second call <<llm_extract>>, the predetermined instruction can include extracting certain data from the output.

In some examples, the second call can include an input that includes the instruction. The system can include the instruction of the input in the second input prompt.

In some examples, the system can include an instruction to extract data identified by an identifier from the output in the second input prompt. In some examples, the second call can include an input that includes an identifier of the data to be extracted. As a particular example, the instruction can include an instruction to perform in-context question answering. For example, the call 204 of FIG. 2 above includes an input that includes “hiking trail names” that identifies data to be extracted from the output <<places>>.

In some examples, the system can include an instruction to format the output of the second generative neural network in the second input prompt. In some examples, the second call can include an input that includes a desired format. For example, the call 204 of FIG. 2 above includes an input that includes “newline delimited” that identifies the desired format of the second generative neural network given the second input prompt.

FIG. 5 shows an example training data generation system 500. The system 500 is an example of a system implemented as computer programs on one or more computers in one or more locations in which the systems, components, and techniques described below are implemented.

The system 500 generates multiple training examples 530. Each training example 530 includes a query 502 and a modified code trajectory 512. The modified code trajectory 512 includes a single snippet of code that, when executed, generates a response for the query 502.

The system 500 can generate training samples for training, e.g., for further training, the generative neural network 120 described above with reference to FIG. 1. A training system of the system 500 or another training system can train the generative neural network 120 on the training data generated by the system 500.

To generate the training example 530, the system 500 obtains a query 502. The query 502 includes 102 can include text that includes a question or an instruction. As a particular example, the query 502 can include “best hikes near Los Angeles: compare them by distance, difficulty, and elevation.”

The system 500 obtains a code trajectory 504 for the query 502. The code trajectory 504 includes a sequence of steps for generating a response to the query 502. Each step can include a snippet of code for the step, an output generated from executing the snippet of code for one or more preceding steps, or both. Thus the steps can include iterative steps, where at least some of the steps use an output generated from executing a snippet of code from one or more preceding steps.

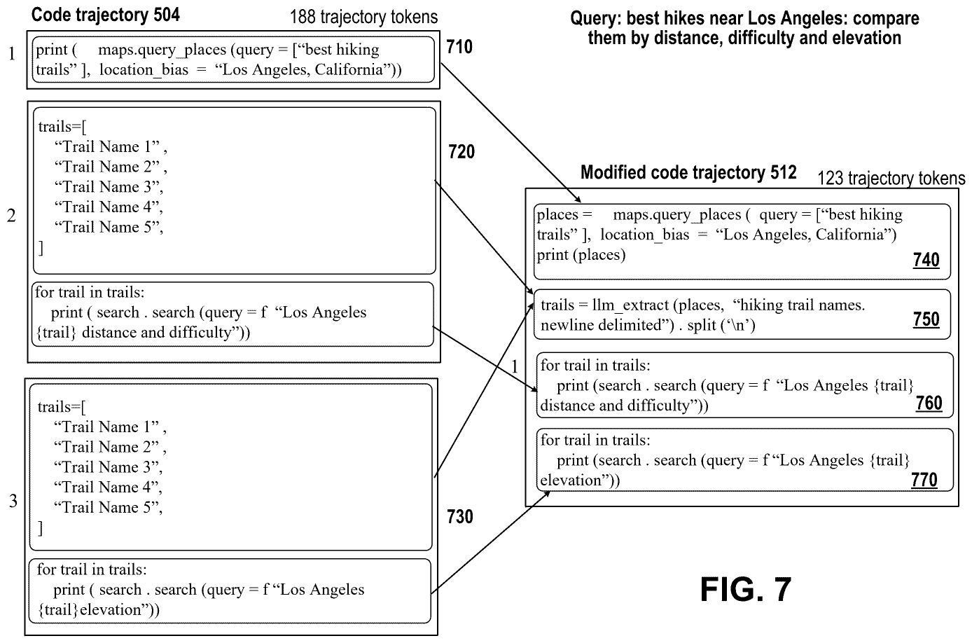

In some examples, one or more of the snippets of code can include one or more respective calls to an external tool. For example, a snippet of code for a step can include a call to a search engine tool as described above with reference to FIG. 1. An example code trajectory 504 is shown with reference to FIG. 7.

In some examples, the system 500 can obtain the query 502 and the code trajectory 504 from an existing set of training examples. Each existing training example can include a training input that includes the query 502 and a target output that includes the code trajectory 504. For example, the existing set of training examples can include training examples for training a generative neural network to generate a code trajectory with multiple steps for a given query. In some examples, the generative neural network 510 described below can have been trained on the set of training examples.

The system 500 generates a modified code trajectory 512 for the code trajectory 504. The modified code trajectory 512 includes a single snippet of code that, when executed, generates the response to the query 502.

In some examples, the single snippet of code of the modified code trajectory 512 includes a call to a fourth generative neural network. The fourth generative neural network can be the generative neural network 510, or another generative neural network. An example modified code trajectory 512 for the code trajectory 504 is shown with reference to FIG. 7.

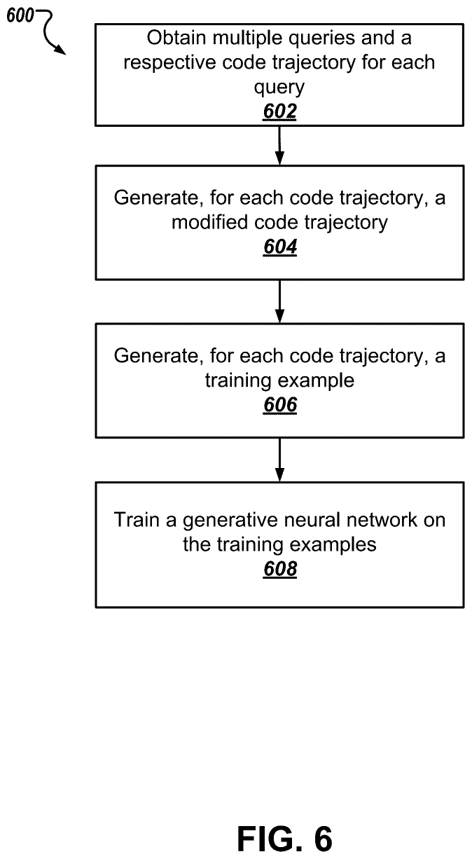

The system 500 can generate the modified code trajectory 512 using a generative neural network 510, also referred to as a third generative neural network. Generating the modified code trajectory 512 using the generative neural network 510 is described in further detail with reference to FIG. 6.

An example generative neural network 510 is described above with reference to FIG. 1 as the generative neural network 120.

In some implementations, the generative neural network 510 and the generative neural network 120 can be the same generative neural network. For example, the generative neural network 120 can have been pre-trained on a language modeling task to determine trained values of parameters of the generative neural network 120. The system 500 can use a current version, e.g., instance or training checkpoint, of the generative neural network 120 to generate training examples for training a future version, e.g., instance or training checkpoint, of the generative neural network 120. For example, at least some of the trained values can be adjusted, e.g., through fine-tuning, reinforcement learning from human feedback, or another suitable training technique. The system can use the future version of the generative neural network 120 as the generative neural network 510. By using the generative neural network 120 as the generative neural network 510, the system can reduce the amount of computing resources required to train the generative neural network 510 compared to training separate generative neural networks.

The system generates the training example 530 to include the query 502 as the training input, and the modified code trajectory 512 as the target output.

The system 500 can generate training examples such as the training example 530 for a large number of different code trajectories, e.g., code trajectories of different lengths or number of steps, or code trajectories that generate responses for different types of queries. The system 500 can thus generate a large dataset of training examples for training the generative neural network 510 to perform code generation.

The system 500 trains the generative neural network 120 on training examples 530. For example, the system 500 updates the values for the generative neural network 120 using a machine learning training technique, e.g., a gradient descent with backpropagation training technique that uses a suitable optimizer, e.g., stochastic gradient descent, RMSprop, Adam optimizer, or Adafactor optimizer, to optimize an objective function, e.g., a cross-entropy objective function that is specific to a next token prediction task.

The system 500 can then determine, based on computing the gradients of the objective function with respect to the parameters of the generative neural network 120, one or more updates to the values of the parameters of the generative neural network 120.

Training the generative neural network 120 on training data generated by the system 500 results in better performance at inference compared to a generative neural network trained on a limited amount of training data. For example, training the generative neural network 120 on a larger number and greater variation of training examples allows the generative neural network 120 to generalize better to previously unseen inputs at inference.

In some examples, instead of or in addition to using the training examples for training, the system can use the training examples as few-shot examples for the generative neural network 120. Each few-shot example can include a query as the training input and the corresponding modified code trajectory as the target output. To generate a snippet of code for a given query as described in FIG. 1 at inference, the system can provide the few-shot examples and the given query as input to the generative neural network 120.

FIG. 6 is a flow diagram of an example process 600 for training a generative neural network. For convenience, the process 600 will be described as being performed by a system of one or more computers located in one or more locations. For example, a system for generating training data, e.g., the system 500 of FIG. 5, appropriately programmed, can perform the process 600.

The system obtains multiple queries and a respective code trajectory for each query (step 602). Each code trajectory can include a sequence of steps for generating a response to the query. Each step can include any one or more of: a snippet of code, or an output generated from causing a snippet of code from one or more preceding steps to be executed.

The system generates, for each code trajectory, a modified code trajectory (step 604). The modified code trajectory for a code trajectory includes a single snippet of code that, when executed, generates the response to the query corresponding to the code trajectory.

For example, for each code trajectory, the system can process at least the code trajectory using a third generative neural network to generate the modified code trajectory. For example, the system can process the code trajectory and an instruction to generate a single snippet of code for the code trajectory using the third generative neural network. In some examples, each step includes a snippet of code. The system can include a text delimiter in between each code snippet in the code trajectory.

In some examples, the instruction can include one or more code translation examples as few-shot prompt examples. Each code translation example can include an example code trajectory and an example modified code trajectory for the example code trajectory. In some examples, each step in each example code trajectory includes a snippet of code. The system can include a text delimiter in between each code snippet in the example code trajectory.

In some examples, for each code trajectory, the system can select the modified code trajectory from multiple candidate modified code trajectories. For example, the system can process at least the code trajectory using the third generative neural network to generate multiple candidate modified code trajectories. As an example, the system can sample from the third generative neural network given at least the code trajectory.

The system can select the modified code trajectory from the candidate modified code trajectories based on a score for each of the candidate modified code trajectories. For example, the system can select the candidate modified code trajectory with the highest score.

In some examples, the score can be based on any one or more of a code quality measure for the candidate modified code trajectory, a tool parallelization measure for the candidate modified code trajectory, or a tool call similarity measure for the candidate modified code trajectory.

The code quality measure can measure the quality of the snippet of code of the candidate modified code trajectory, e.g., whether the snippet of code, when executed, generates the same response as the code trajectory, how similar the response generated upon execution of the snippet of code is to the response generated upon execution of the code trajectory, or whether the snippet of code includes code that is syntactically correct or has errors. For example, the system can determine a code quality measure that measures how similar the response generated upon execution of the snippet of code is to the response generated upon execution of the code trajectory by comparing, e.g., string comparison, semantic comparison, or embedding difference, the response generated upon execution of the snippet of code with the response generated upon execution of the code trajectory. As another example, the system can determine a code quality measure that measures whether the snippet of code includes code that is syntactically correct by processing the snippet of code using a syntax checker. As another example, the system can determine a code quality measure that measures whether the snippet of code includes code that has errors by processing the snippet of code using a static analysis tool, e.g., a lint tool.

The tool parallelization measure can measure how many tool calls of the candidate modified code trajectory can be performed in parallel, e.g., whether a tool call is dependent on the outputs of any previous tool calls. For example, the system can construct a data dependency graph G, where the graph nodes represent tool calls, and a graph edge between two nodes represents whether the inputs of the tool call for the first node depend on the outputs of the tool call for the second node. For example, the system can include an edge between the node A for tool call A and the node B for tool call B if the inputs of the tool call B depend on the outputs of the tool call A. The system can determine a set of disconnected subgraphs S of the graph G by repeatedly running a breadth first search until all graph nodes have been visited. The system can determine the tool parallelization measure by dividing the number of disconnected subgraphs by the number of tool calls. For example, if all tool calls are independent and thus parallelizable, the tool parallelization measure can be 1.0. If all tool calls are dependent in series and thus not parallelizable, the tool parallelization measure can be 1/(the number of tool calls).

The tool call similarity measure can measure the similarity between the tool calls of the candidate modified code trajectory and the code trajectory. For example, the tool call similarity measure can be based on the fraction of identical tool calls in the candidate code trajectory and the code trajectory. In some examples, an identical tool call in the candidate modified code trajectory includes a call to the same external tool as the tool call in the code trajectory. In some examples, an identical tool call in the candidate modified code trajectory includes a call with the same inputs as the tool call in the code trajectory. For example, the system can perform a string comparison between tool calls in the candidate modified code trajectory and the code trajectory to determine the number of identical tool calls. The system can determine the fraction of identical tool calls based on the total number of tool calls in the code trajectory.

In some examples, the system can filter the candidate modified code trajectories to not include one or more candidate modified code trajectories. For example, the system can filter out candidate modified code trajectories for which the score does not meet a threshold score.

In some examples, the system can rank the candidate modified code trajectories based on the score. For example, the system can rank the candidate modified code trajectories in order of descending score. The system can select the modified code trajectory as the top-ranked or one of the top-k ranked candidate modified code trajectories.

In some examples, the third generative neural network is the generative neural network to be trained. For example, the generative neural network can have been pre-trained to determine trained values of parameters of the generative neural network, e.g., on a language modeling objective. In these examples, to process at least the code trajectory using the third generative neural network, the system processes at least the code trajectory in accordance with the trained values of the parameters of the generative neural network.

In some examples, the single snippet of code can include a call to a fourth generative neural network. In some examples, the fourth generative neural network is the third generative neural network.

The system generates, for each code trajectory, a training example (step 606). The training example for a code trajectory includes the modified code trajectory for the code trajectory and the query for the code trajectory.

The system trains a generative neural network on the training examples (step 608). For example, the system can further train, e.g., fine-tune, the generative neural network on the training examples.

FIG. 7 shows an example code trajectory 504 and an example modified code trajectory 512. The example code trajectory 504 and example modified code trajectory 512 correspond to the query “best hikes near Los Angeles: compare them by distance, difficulty and elevation.”

The code trajectory 504 includes at least three steps 710, 720, and 730. Each step includes a snippet of code generated at the step, an output, or both. For example, the step 710 includes a snippet of code that calls an external tool <<maps.query_places>>. Upon execution of the snippet of code for step 710, the system prints the output of the external tool.

The step 720 includes the output of the step 710 as a corresponding output for the step 720. For example, the output of the step 710 includes the output of the print statement of the step 710. To generate the snippet of code for the step 720, the system can provide at least the corresponding output for the step 720, e.g., the output of the step 710, as input to a generative neural network. The input can also include, for example, any one or more of the query, the snippet of code of the step 710, an instruction to generate code for the next step for answering the query or to generate a response to the query if there is enough information, and a description of available tools. Given the input for the step 720, the generative neural network generates a snippet of code for the step 720 that initializes the list <<trails>> and calls an external tool <<search.search>> for each trail in <<trails>>.

The step 730 includes the output of the step 710, the output of the step 720, or both, as a corresponding output for the step 730. To generate the snippet of code for the step 730, the system can provide at least the corresponding output for the step 730, e.g., the output of the step 710, as input to the generative neural network. The input can also include, for example, any one or more of the query, the snippet of code of the step 710 or the step 720, an instruction to generate code for the next step for answering the query or to generate a response to the query if there is enough information, and a description of available tools. Given the input for the step 730, the generative neural network generates a snippet of code for the step 730 that initializes the list <<trails>> and calls an external tool <<search.search>> for each trail in <<trails>>.

The modified code trajectory 512 includes a single snippet of code. FIG. 7 shows that each of the steps 710, 720, and 730 has one or more corresponding sections of code in the modified code trajectory 512. The corresponding section of code, when executed, performs the same operations as the corresponding step.

For example, the section of code 740 corresponds to the step 710. The section of code 740 includes the same call to the external tool as the snippet of code of step 710. When executed, the section of code 740 and the snippet of code of step 710 generate the same output.

The section of code 750 corresponds to the step 720 and the step 730. The section of code 750 includes code that, when executed, generates the same output, search results for each trail in <<trails>> as the corresponding output of the steps 720 and 730.

The section of code 760 corresponds to the step 720. The section of code 750 includes the same calls to the external tool as the snippet of code of step 720. When executed, the section of code 760 and the snippet of code of step 720 generate the same output.

The section of code 770 corresponds to the step 730. The section of code 770 includes the same calls to the external tool as the snippet of code of step 730. When executed, the section of code 770 and the snippet of code of step 730 generate the same output.

Thus, the modified code trajectory 512 performs the same operations when executed as the code trajectory 504, while being executed in a single pass rather than iteratively. The modified code trajectory 512 is also generated using a single call to the generative neural network as described above. For example, generating the modified code trajectory 512 does not require iteratively providing different input prompts to the generative neural network at each of multiple steps to generate a snippet of code for the step.

FIG. 7 shows that the total number of tokens generated in the modified code trajectory 512 is less than the total number of tokens generated for the code trajectory 504. FIG. 7 also shows that fewer calls to a generative neural network are required to generate the modified code trajectory 512 than are required for the code trajectory 504. Furthermore, because the modified code trajectory 512 is executed in one pass, the system can use the call to the generative neural network, <<llm_extract>>, to define the variable <<trails>> that can be used throughout the single snippet of code, rather than printing and providing the output of the step 710 as input to a generative neural network at each of multiple steps in the code trajectory 504. For example, the inputs to steps 720 and 730 both include the output of the step 710, and the snippets of code generated for step 720 and for step 730 both include an initialization of <<trails>>. Thus, by generating modified code trajectories for queries, the system can generate training data for training a generative neural network to generate a single snippet of code for responding to queries in a manner that conserves computational time and resources.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:

Embodiment 1 is a computer-implemented method comprising: receiving a query; generating an input prompt for a generative neural network from the query; processing the input prompt using the generative neural network to generate a snippet of code, wherein the snippet of code comprises a sequence of calls, the sequence of calls comprising a first call to an external tool and a second call to a second generative neural network; and executing the snippet of code to generate a response to the query.

Embodiment 2 is the method of embodiment 1, wherein the second generative neural network is the generative neural network.

Embodiment 3 is the method of any of embodiments 1-2, wherein the snippet of code assigns a variable name to an output of the first call to the external tool.

Embodiment 4 is the method of embodiment 3, wherein the second call comprises one or more inputs, and wherein the one or more inputs comprise the variable name.

Embodiment 5 is the method of embodiment 4, wherein executing the snippet of code comprises: calling the external tool according to the first call; assigning the variable name to the output of the first call; and calling the second generative neural network according to the second call by processing a second input prompt comprising the output identified by the variable name using the second generative neural network.

Embodiment 6 is the method of embodiment 5, wherein calling the second generative neural network according to the second call comprises generating the second input prompt by including the output identified by the variable name in the second input prompt.

Embodiment 7 is the method of embodiment 6, wherein generating the second input prompt comprises including an instruction to generate an answer to a question about the output.

Embodiment 8 is the method of any of embodiments 6-7, wherein the one or more inputs comprise an identifier of data to be extracted from the output, and wherein generating the second input prompt comprises including an instruction to extract data identified by the identifier from the output.

Embodiment 9 is the method of any of embodiments 1-8, wherein the snippet of code comprises code that, when executed, generates the response to the query based on an output of the second generative neural network.

Embodiment 10 is a computer-implemented method comprising: obtaining a plurality of queries and a respective code trajectory for each query, wherein each code trajectory comprises a sequence of steps for generating a response to the query, wherein each step comprises any one or more of: a snippet of code, or an output generated from causing a snippet of code from one or more preceding steps to be executed; generating, for each code trajectory, a modified code trajectory, wherein the modified code trajectory comprises a single snippet of code that, when executed, generates the response to the query; generating, for each code trajectory, a training example, wherein the training example comprises the modified code trajectory for the code trajectory and the query for the code trajectory; and training a generative neural network on the training examples.

Embodiment 11 is the method of embodiment 10, wherein generating, for each code trajectory, the modified code trajectory comprises: processing at least the code trajectory using a third generative neural network to generate the modified code trajectory.

Embodiment 12 is the method of any of embodiments 10-11, wherein the single snippet of code comprises a call to a fourth generative neural network.

Embodiment 13 is the method of any of embodiments 11-12, wherein processing at least the code trajectory using the third generative neural network comprises processing the code trajectory and an instruction to generate a single snippet of code for the code trajectory using the third generative neural network.

Embodiment 14 is the method of embodiment 13, wherein the instruction further comprises one or more code translation examples, each comprising an example code trajectory and an example modified code trajectory.

Embodiment 15 is the method of any of embodiments 11-14, wherein the third generative neural network is the generative neural network.

Embodiment 16 is the method of embodiment 15, wherein the generative neural network has been pre-trained on a language modeling task to determine trained values of parameters of the generative neural network, and wherein processing at least the code trajectory using the third generative neural network comprises processing at least the code trajectory in accordance with the trained values of the parameters of the generative neural network.

Embodiment 17 is the method of any of embodiments 10-16, wherein generating, for each code trajectory, the modified code trajectory comprises: processing at least the code trajectory using a third generative neural network to generate a plurality of candidate modified code trajectories; and selecting the modified code trajectory from the candidate modified code trajectories based on any one or more of a code quality measure for each candidate modified code trajectory, a tool call similarity measure for each candidate modified code trajectory, or a tool parallelization measure for each candidate modified code trajectory.

Embodiment 18 is the method of any of embodiments 10-17, wherein one or more of the snippets of code comprise a respective call to an external tool.

Embodiment 19 is the method of embodiment 18, wherein the single snippet of code comprises the respective calls of the one or more snippets of code.

Embodiment 20 is a system comprising one or more computers and one or more storage devices communicatively coupled to the one or more computers, wherein the one or more storage devices store instructions that, when executed by the one or more computers, cause the one or more computers to perform operations of the respective method of any of embodiments 1-19.

Embodiment 21 is one or more non-transitory computer storage media encoded with computer program instructions that when executed by a plurality of computers cause the plurality of computers to perform operations of the respective method of any of embodiments 1-19.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a query;
generating an input prompt for a generative neural network from the query;
processing the input prompt using the generative neural network to generate a snippet of code, wherein the snippet of code comprises a sequence of calls, the sequence of calls comprising a first call to an external tool and a second call to a second generative neural network; and
executing the snippet of code to generate a response to the query.

2. The method of claim 1, wherein the second generative neural network is the generative neural network.

3. The method of claim 1, wherein the snippet of code assigns a variable name to an output of the first call to the external tool.

4. The method of claim 3, wherein the second call comprises one or more inputs, and wherein the one or more inputs comprise the variable name.

5. The method of claim 4, wherein executing the snippet of code comprises:
calling the external tool according to the first call;
assigning the variable name to the output of the first call; and
calling the second generative neural network according to the second call by processing a second input prompt comprising the output identified by the variable name using the second generative neural network.

6. The method of claim 5, wherein calling the second generative neural network according to the second call comprises generating the second input prompt by including the output identified by the variable name in the second input prompt.

7. The method of claim 6, wherein generating the second input prompt comprises including an instruction to generate an answer to a question about the output.

8. The method of claim 6, wherein the one or more inputs comprise an identifier of data to be extracted from the output, and wherein generating the second input prompt comprises including an instruction to extract data identified by the identifier from the output.

9. The method of claim 1, wherein the snippet of code comprises code that, when executed, generates the response to the query based on an output of the second generative neural network.

10. A computer-implemented method comprising:
obtaining a plurality of queries and a respective code trajectory for each query, wherein each code trajectory comprises a sequence of steps for generating a response to the query, wherein each step comprises any one or more of: a snippet of code, or an output generated from causing a snippet of code from one or more preceding steps to be executed;
generating, for each code trajectory, a modified code trajectory, wherein the modified code trajectory comprises a single snippet of code that, when executed, generates the response to the query;
generating, for each code trajectory, a training example, wherein the training example comprises the modified code trajectory for the code trajectory and the query for the code trajectory; and
training a generative neural network on the training examples.

11. The method of claim 10, wherein generating, for each code trajectory, the modified code trajectory comprises:
processing at least the code trajectory using a third generative neural network to generate the modified code trajectory.

12. The method of claim 10, wherein the single snippet of code comprises a call to a fourth generative neural network.

13. The method of claim 11, wherein processing at least the code trajectory using the third generative neural network comprises processing the code trajectory and an instruction to generate a single snippet of code for the code trajectory using the third generative neural network.

14. The method of claim 13, wherein the instruction further comprises one or more code translation examples, each comprising an example code trajectory and an example modified code trajectory.

15. The method of claim 11, wherein the third generative neural network is the generative neural network.

16. The method of claim 15, wherein the generative neural network has been pre-trained on a language modeling task to determine trained values of parameters of the generative neural network, and wherein processing at least the code trajectory using the third generative neural network comprises processing at least the code trajectory in accordance with the trained values of the parameters of the generative neural network.

17. The method of claim 10, wherein generating, for each code trajectory, the modified code trajectory comprises:
processing at least the code trajectory using a third generative neural network to generate a plurality of candidate modified code trajectories; and
selecting the modified code trajectory from the candidate modified code trajectories based on any one or more of a code quality measure for each candidate modified code trajectory, a tool call similarity measure for each candidate modified code trajectory, or a tool parallelization measure for each candidate modified code trajectory.

18. The method of claim 10, wherein one or more of the snippets of code comprise a respective call to an external tool.

19. The method of claim 18, wherein the single snippet of code comprises the respective calls of the one or more snippets of code.

20. A system comprising:
one or more computers; and
one or more storage devices communicatively coupled to the one or more computers, wherein the one or more storage devices store instructions that, when executed by the one or more computers, cause the one or more computers to perform operations comprising:
receiving a query;
generating an input prompt for a generative neural network from the query;
processing the input prompt using the generative neural network to generate a snippet of code, wherein the snippet of code comprises a sequence of calls, the sequence of calls comprising a first call to an external tool and a second call to a second the generative neural network; and
executing the snippet of code to generate a response to the query.
